(19) United States
(12) Patent Application Publication
(10) Pub. No.: US 2005/0179390 A1
(43) Pub. Date: Aug. 18, 2005

(54) Compact fluorescent lamp

(75) Inventors: Earl F. Crandall, Raleigh, NC (US); Robert C. Smallwood SR., Englewood, CO (US); Christopher M. Hobbs, Alexandria, VA (US)

Correspondence Address: BURNS DOANE SWECKER & MATHIS L L P, POST OFFICE BOX 1404, ALEXANDRIA, VA, 22313-1404, US

(73) Assignee: Transworld Lighting, Inc.

(21) Appl. No.: 10/817,181

(22) Filed: Apr. 2, 2004

Related U.S. Application Data
(60) Provisional application No. 60/460,505, filed on Apr. 4, 2003.

(51) Int. Cl. H01J 61/02

(52) U.S. Cl. 313/635

(57) ABSTRACT

A gas discharge lamp includes a base configured to receive electrical power from a power source and a high frequency ballast electrically connected to the base and configured to convert the electrical power to a high frequency AC waveform for driving a gas discharge tube. The gas discharge tube is configured to receive the high frequency AC waveform and emit UV light by passing the high frequency AC waveform through a mixture of gases contained within the gas discharge tube and to emit UV photons in response. A visible light emitting surface has a glass envelope of different geometry than the gas discharge tube and a phosphor coating is placed on the inside of the glass envelope. The glass envelope seals a volume around the gas discharge tube that is at least partially evacuated.

### RELATED APPLICATIONS

This application claims priority under 37 C.F.R. § 119 to provisional application Ser. No. 60/460,505, filed on Apr. 4, 2003, entitled “Compact Fluorescent Lamp,” which is incorporated by reference herein in its entirety.

### BACKGROUND

The invention relates generally to gas discharge lamps. More specifically, this invention relates to compact fluorescent lamps (CFLs) that are configured so as to allow the visible light emitting surface of the CFLs to be altered independently of a UV light emitting gas discharge tube.

FIG. 1 shows the cross-section for a conventional compact fluorescent lamp (CFL) that is representative of the current industry standard. The gas discharge tube used to produce UV photons is also used as the visible light emitting surface of the lamp. Therefore, the visible light emitting surface and the gas discharge tube cannot be independently altered.

### SUMMARY

In one aspect of the invention, a gas discharge lamp includes a base configured to receive electrical power from a power source and a high frequency ballast electrically connected to the base and configured to convert the electrical power to a high frequency AC waveform for driving a gas discharge tube. The gas discharge tube is configured to receive the high frequency AC waveform and emit UV light by passing the high frequency AC waveform through a mixture of gases contained within the gas discharge tube and to emit UV photons in response. A visible light emitting surface has a glass envelope of different geometry than the gas discharge tube and a phosphor coating is placed on the inside of the glass envelope. The glass envelope seals a volume around the gas discharge tube that is at least partially evacuated.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a cross-sectional view of a prior art CFL.

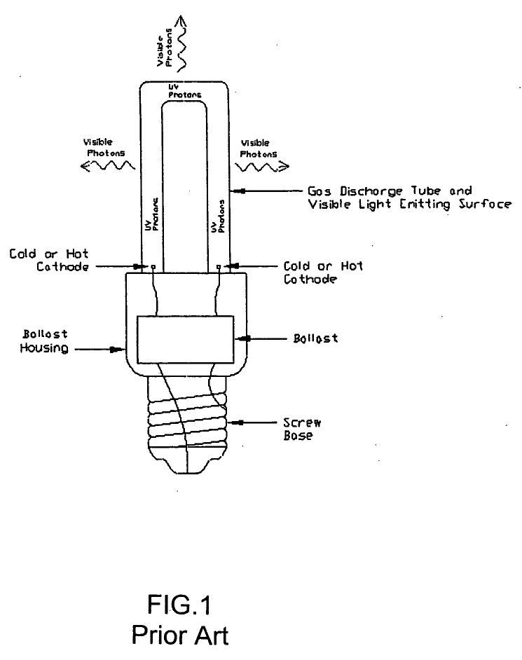

FIG. 2 is a cross-sectional view of a CFL according to an embodiment of the present invention.

### DETAILED DESCRIPTION

CFLs according to the invention are configured to allow the visible light emitting surface of the CFLs to be altered independently of a UV light emitting gas discharge tube. This allows the geometry (i.e., surface area, shape, dimensions, cross-sections) of each component (i.e., visible light emitting surface and UV light emitting gas discharge tube) to be independently optimized for any application. Typical applications may include, but are not limited to: white lights, colored lights, multi-colored lights, and lights of various shapes for advertising, architectural design, etc.

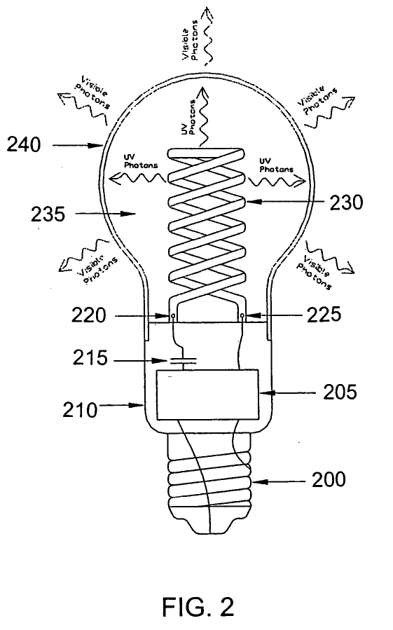

A cross section of a preferred embodiment for the new CFL is shown in FIG. 2. A detailed description of each of its components and its operation follows.

Electrical power is applied to the CFL through its base 200. In a preferred embodiment this is a standard candelabra base for compatibility with standard candelabra light fixtures used in the United States. However, the base 200 could be of any standard type used in the lighting industry of any country or government, or a nonstandard type for special applications.

The base 200 of the CFL is electrically connected to a high frequency ballast 205. A high frequency ballast 205 is defined here as a lamp driver capable of powering the lamp at any frequency above 1 KHz. A preferred embodiment operates in a frequency range of about 100 KHz to about 450 KHz. The purpose of the high frequency ballast 205 is to convert the electric power supplied to the base 200 of the CFL to a high frequency AC waveform suitable for driving a gas discharge tube 230. In an exemplary embodiment, the electrical input to the ballast 205 is 110 Volt 50/60 Hz AC for compatibility with standard light fixtures. However, it could also be a DC input of any voltage, or an AC input of any voltage and frequency. In these cases the ballast 205 would be modified to accept the desired electrical input while producing a high frequency AC output suitable for driving the gas discharge tube 230.

The output from the high frequency ballast 205 is fed through a DC blocking capacitor 215 before it is supplied to electrodes 220, 225 of the gas discharge tube 230. The purpose of the DC blocking capacitor 215 is to remove any DC voltage component from the high frequency AC waveform generated in the ballast 205. This is required because DC currents will result in electrolysis reactions inside the gas discharge tube 230 that will shorten its lifespan.

The electrical output from the high frequency ballast 205 and DC blocking capacitor 215 is fed into the electrodes 220, 225 of the gas discharge tube 230. These electrodes 220, 225 are preferably one of two types, cold cathode or hot cathode. The choice will depend on the specific design of the gas discharge tube 230 and will be familiar to those skilled in the art of their manufacture. The purpose of the gas discharge tube 230 is to produce and emit UV light. This is accomplished by passing the high frequency AC current from the ballast 205 through the mixture of gases contained within the tube 230. The composition of the gas mixture will be familiar to those skilled in the art of gas discharge tube manufacture. For example, argon and/or xenon can be used, among others.

As the current passes through the gas mixture it excites certain chemical species which emit UV light. It is preferred that the gas discharge tube 230 be constructed from UV TRANSPARENT material such that the UV light generated inside of it can pass through the tube wall with minimal attenuation. As shown, the gas discharge tube 230 may have a helical geometry. However, there are no limitations placed on its geometry other than it is different from that of the visible light emitting surface. The gas discharge tube 230 may also be formed, for example, as a cylinder, spiral, beehive, or multiple U tubes.

The gas discharge tube 230 is surrounded by a visible light emitting surface (VLES) 240. The VLES 240 is composed of a second glass envelope of different geometry (i.e. surface area, shape, dimensions, cross-sections) than the gas discharge tube 230, which is sealed and attached to a ballast housing 210 housing the ballast 205. The sealed volume 235 between the VLES 240 and the gas discharge tube 230 may be evacuated, partially evacuated, pressurized or filled with any mixture of gases known to those skilled in the art to minimize heat loss from the gas discharge tube 230, thereby improving the thermal efficiency of the CFL. The UV photons emitted from the gas discharge tube are absorbed by a phosphor coating placed on the inside of the VLES 240. The phosphor converts the UV photons to visible photons which are transmitted through and emitted from the VLES 240. The glass used to construct the VLES 240 preferably blocks any UV photons that are not absorbed by the phosphor coating on its inside surface. The geometry of the VLES 240 is shown as the familiar tear drop of an incandescent lamp. However, there are no limitations placed on the geometry of the VLES 240 other than it is different from that of the gas discharge tube. Thus, the geometry of the VLES 240 could be of any shape for use as bulbs, lights, signs, advertising, or art.

It will be appreciated by those of ordinary skill in the art that the invention can be embodied in various specific forms without departing from its essential characteristics. The disclosed embodiments are considered in all respects to be illustrative and not restrictive. The scope of the invention is indicated by the appended claims, rather than the foregoing description, and all changes that come within the meaning and range of equivalents thereof are intended to be embraced thereby.

It should be emphasized that the terms “comprises”, “comprising”, “includes”, and “including”, when used in this description and claims, are taken to specify the presence of stated features, steps, or components, but the use of these terms does not preclude the presence or addition of one or more other features, steps, components, or groups thereof.

1. A gas discharge lamp, comprising:
a base configured to receive electrical power from a power source;
a high frequency ballast electrically connected to the base and configured to convert the electrical power to a high frequency AC waveform for driving a gas discharge tube;
the gas discharge tube configured to receive the high frequency AC waveform and emit UV light by passing the high frequency AC waveform through a mixture of gases contained within the gas discharge tube and to emit UV photons in response; and
a visible light emitting surface (VLES) having a glass envelope of different geometry than the gas discharge tube and a phosphor coating placed on the inside of the glass envelope, the glass envelope sealing a volume around the gas discharge tube that is at least partially evacuated.

2. The gas discharge lamp of claim 1, comprising a DC blocking capacitor configured to block DC current from the high frequency ballast from reaching the gas discharge tube.

3. The gas discharge lamp of claim 1, wherein the base is a standard candelabra base.

4. The gas discharge lamp of claim 1, wherein the high frequency AC waveform is in a frequency range of about 100 KHz to about 450 KHz.

5. The gas discharge lamp of claim 1, wherein the gas discharge tube includes electrodes for receiving the high frequency AC waveform from the gas discharge tube, the electrodes being one of a cold cathode and a hot cathode type.

6. The gas discharge lamp of claim 1, wherein the gas discharge tube comprises UV transparent material.

7. The gas discharge lamp of claim 1, wherein the mixture of gases includes at least one of argon and xenon.

8. The gas discharge lamp of claim 1, wherein a geometry of the gas discharge tube is one of helical, cylindrical, spiral, beehive, and multiple U tubes.

9. The gas discharge lamp of claim 1, wherein the phosphor coating on the inside of the glass envelope is configured to convert UV photons emitted by the gas discharge tube into visible light photons.

10. The gas discharge lamp of claim 9, wherein the glass envelope is configured to block UV photons that are not converted by the phosphor coating.

11. The gas discharge lamp of claim 1, wherein the VLES is configured for use as a sign.
